(19) United States
(12) Patent Application Publication
(10) Pub. No.: US 2018/0281883 A1
(43) Pub. Date: Oct. 4, 2018

(54) GUARD FOR A SEAT POST

(71) Applicant: 100% Carbon Limited, Owhango (NZ)

(72) Inventor: Alastair Morris Mckinlay, Owhango (NZ)

(73) Assignee: 100% Carbon Limited, Owhango (NZ)

(21) Appl. No.: 15/937,894

(22) Filed: Mar. 28, 2018

(30) Foreign Application Priority Data
Mar. 31, 2017 (NZ) 730653

(51) Int. Cl. B62J 23/00; B62J 1/08

(52) U.S. Cl. CPC B62J 23/00; B62J 1/08

(57) ABSTRACT

A guard for bicycles is disclosed. The guard is configured to be connected to the seat of the bicycle and is oriented substantially in line with the side of the seat post of the bicycle that faces the rear wheel. A guide, mounted proximate the top of the seat tube where the seat post or a seat height adjustment mechanism is inserted, is provided for an end of the guard. As the seat height is adjusted when riding, the movement of the guard is optimized to provide continual protection for the seat post and seat height adjustment mechanism. This helps prevent or reduce contact of mud and debris with the seat post and the seat height adjustment mechanism being drawn into the interior of the seat tube.

### CROSS REFERENCE TO RELATED APPLICATION

This application claims the benefit of New Zealand Patent Application No. 730653 filed Mar. 31, 2017. The subject matter of this earlier filed application is incorporated herein by reference in its entirety.

### FIELD

The present invention generally relates to an accessory for a bicycle, and more particularly, to a device for use with the seat post of a bicycle that has particular application to bicycles having an adjustable seat, as is commonly seen in mountain bikes.

### BACKGROUND

Various devices are known for protecting bicycles, bicycle components, and/or their riders from mud, dirt, and rocks/pebbles (hereinafter collectively referred to as “debris”) thrown up by the tires in use. Most common among these are “mudguards,” which typically are elongate guards or shields fixed to a portion of the bicycle.

Mudguards are generally intended to arrest the trajectory of debris early in its flight and stop or minimize such debris from contacting the rider or other components of the bicycle. Accordingly, mudguards tend to be mounted close to the tires and be configured to provide a substantially horizontal “barrier” between the tires and the remainder of the bicycle. Some mudguards are formed in an arc-shape that is substantially complementary to the curvature of the tire. This configuration enables the mudguard to be closely mounted to the tire.

However, conventional mudguards do not always provide effective protection to other components of the bicycle. Any debris that is not successfully blocked by the mudguard may then proceed to come into contact with unprotected bicycle components. In muddy conditions, debris thrown by the tires can rapidly accumulate around the mudguard and inhibit free movement of the wheels. Therefore, in some cycling activities, such as mountain biking, mudguards may be removed altogether by the rider. This presents the problem of leaving the rider, frame, and components of the bicycle exposed to debris thrown up by the wheels.

Devices presenting alternative ways of protection by providing a guard or shield mounted proximate a particular component(s) of the bicycle are known. These devices aim to protect the relevant component(s) at the point of impact of debris. Among these are devices for protecting the seat post (also known as a “dropper post”) of the bicycle from impact. Some seat posts are simply tubes that are inserted into a corresponding seat post tube, which is the cylindrical member of the bicycle frame that accommodates the seat post. The seat post is held in place with a lever-operated clamp for the user to adjust the height as desired.

However, more complex seat posts include a piston-like assembly, to which the seat is attached, that moves up and down within a tube housing that, in turn, is inserted into the corresponding seat post tube of the frame of the bicycle. These seat posts can be operable via a switch or button mounted to the handlebars so that the height of the seat can be adjusted while the bicycle is in motion. This is particularly convenient for mountain bikes where, during downhill rides, it is preferable to lower the seat.

Seat posts can be expensive components as they are usually formed from coated metal for corrosion resistance and the complex seat posts include electronic or pneumatic clamping or adjustment mechanisms. Furthermore, due to their location relative to the rear of the bicycle, seat posts tend to be directly in the line of debris thrown up by the rear tire in use. Debris impacting the seat post may cause damage to its coating, such as by chipping, scratching, or denting.

Moreover, debris may often settle at the entrance of the seat tube. The entrance of the seat tube, which as noted above, incorporates clamping and/or height adjustment mechanisms for the seat post, can act as a natural settling area for debris, which may subsequently be drawn into the seat tube or tube housing when the seat post or the piston is lowered. Any debris that settles on the seat post itself may likewise be drawn into the seat tube in this manner. This may risk damage to both the seat tube and the seat post, as well as potentially jam the mechanism.

This may be particularly problematic for the complex seat posts that are configured to be adjusted while the bicycle is being ridden. In such seat posts, the piston may repeatedly slide up and/or down during use to allow the rider to adjust the seat depending on whether he or she is riding cross country or downhill.

Although any accumulated debris on the seat post may be wiped off by the rider, this will require dismounting, which can be inconvenient. Furthermore, while cycling, the rider may have no opportunity to safely dismount and clean or wipe the seat post and seat tube entrance prior to making an adjustment to the seat post. Hence it is preferable to protect the seat post and tube from debris.

One known seat post protector takes the form of a “sleeve” formed from synthetic foam that wraps around the seat post or piston. However, a drawback of this device is that it can significantly impede the range of motion of the seat post or piston such that the seat cannot be fully lowered. Furthermore, depending on its placement, the device may only protect a portion of the seat post itself, not the entrance to the seat tube or tube housing, which can still remain exposed.

Another known device consists of a flexible strip of material, such as neoprene, which in use is positioned such that it faces the rear of the tire. The strip is connected to the seat post or the piston proximate the seat at one end and to the other end of the post or piston or to the top of the seat tube or tube housing through the use of screws or straps. When the seat is lowered, the strip folds over itself to accommodate this movement. One commercially-available example of such a device is the Neoprene Dropper Seat Post Protector manufactured by PRO™.

However, while this device may allow the seat to substantially retain its range of motion, the strip may only provide proper protection to the piston or seat post when the latter is at one particular height and the strip is substantially flush against its surface. When the seat post is adjusted and the strip begins to fold, it separates away from the seat post or piston and the level of protection it affords is accordingly compromised. Furthermore, when the seat is lowered, the strip folds over, thus protruding away from the seat post or piston in a manner that may risk catching on passing objects, as well as being inelegant in appearance.

More complex devices exist for providing protection to the seat post or piston while aiming to allow it to retain its range of motion. One such example is the ICE Lift V8 Delux, which is a corrugated sleeve that shrouds the entire piston or seat post. However, these devices tend to be intricate, having relatively many components. Furthermore, they tend to require at least partial disassembly of the seat and/or seat post in order to mount to the bicycle.

### SUMMARY

Certain embodiments of the present invention may provide solutions to the problems and needs in the art that have not yet been fully identified, appreciated, or solved by current bicycle accessories. It is an object of the present invention to address the foregoing problems with the prior art, or at the very least, to provide the public with a useful choice. For instance, some embodiments pertain to a guard for bicycles that is configured to be connected to the seat of the bicycle and is oriented substantially in line with the side of the seat post of the bicycle that faces the rear wheel. A guide, mounted proximate the top of the seat tube where the seat post or a seat height adjustment mechanism is inserted, is provided for an end of the guard. As the seat height is adjusted when riding, the movement of the guard is optimized to provide continual protection for the seat post and seat height adjustment mechanism. This helps prevent or reduce contact of mud and debris with the seat post and the seat height adjustment mechanism being drawn into the interior of the seat tube.

In an embodiment, an accessory for a bicycle is provided. The bicycle includes a frame and a seat assembly. The seat assembly includes a seat and a seat post. The seat is connected to a first end of the seat post. The accessory includes an elongate guard having a first end and a second end. The accessory also includes a guide configured to, in use, be connected to the frame and to cooperate with the guard. The guard is configured to, in use, be substantially parallel to the seat post. The first end of the guard is configured to, in use, be connected to the seat assembly proximate the first end of the seat post.

In another embodiment, a kit for an accessory for a bicycle includes the accessory and at least one fastener. The accessory includes an elongate guard having a first end and a second end and a guide configured to, in use, be connected to a frame of the bicycle and to cooperate with the guard. The guard is configured to, in use, be substantially parallel to a seat post of the bicycle. The first end of the guard is configured to, in use, be connected to a seat assembly of the bicycle proximate a first end of the seat post.

In yet another embodiment, a method of mounting an accessory that includes an elongate guard and a guide to a bicycle is provided. The method includes connecting the guide to a frame of the bicycle and connecting a first end of the guard to a seat assembly proximate a first end of a seat post and passing a second end of the guard through the guide. The guard is configured to, in use, be substantially parallel to the seat post.

### BRIEF DESCRIPTION OF THE DRAWINGS

In order that the advantages of certain embodiments of the invention will be readily understood, a more particularly description of the invention briefly described above will be rendered by reference to specific embodiments that are illustrated in the appended drawings. While it should be understood that these drawings depict only typical embodiments of the invention and are not therefore to be considered to be limiting of its scope, the invention will be described and explained with additional specificity and detail through the use of the accompanying drawings, in which:

FIG. 1 is a schematic showing a perspective view of the accessory according to an embodiment of the present invention mounted to a bicycle, the seat of the bicycle is in a raised position;

FIG. 2 is a schematic showing a perspective view of the accessory according to the same embodiment of the present invention mounted to a bicycle, where the seat of the bicycle is in a lowered position; and

FIG. 3 is a schematic showing a profile view of the accessory according to the same embodiment of the present invention mounted to a bicycle, where the seat of the bicycle is in a raised position.

### DETAILED DESCRIPTION OF THE EMBODIMENTS

Some embodiments pertain to a guard for bicycles that is configured to be connected to the seat of the bicycle and is oriented substantially in line with the side of the seat post of the bicycle that faces the rear wheel. A guide, mounted proximate the top of the seat tube where the seat post or a seat height adjustment mechanism is inserted, is provided for an end of the guard. As the seat height is adjusted when riding, the movement of the guard is optimized to provide continual protection for the seat post and seat height adjustment mechanism. This helps prevent or reduce contact of mud and debris with the seat post and the seat height adjustment mechanism being drawn into the interior of the seat tube.

According to one aspect of the invention, there is provided an accessory for a bicycle. The bicycle has a frame and a seat assembly. The seat assembly includes a seat and a seat post. The seat is connected to a first end of the seat post. The accessory includes an elongate guard having a first end and a second end. The guard is configured to, in use, be substantially parallel to the seat post. The first end of the guard is configured to, in use, be connected to the seat assembly proximate the first end of the seat post. The accessory includes a guide configured to, in use, be connected to the frame and to cooperate with the guard.

According to another aspect of the invention, there is provided a method of mounting an accessory to a bicycle. The bicycle has a frame and a seat assembly. The seat assembly includes a seat and a seat post. The seat is connected to a first end of the seat post. The accessory is substantially as described above. The method includes connecting the first end of the guard to the seat assembly proximate the first end of the seat post and connecting the guide to the frame and passing the second end of the guard through the guide.

According to yet another aspect of the invention, there is provided a method of mounting an accessory to a bicycle. The bicycle has a frame and a seat assembly. The seat assembly includes a seat and a seat post. The seat is connected to a first end of the seat post. The accessory is substantially as described above. The method includes connecting the guide to the frame and connecting the first end of the guard to the seat assembly proximate the first end of the seat post and passing the second end of the guard through the guide.

The accessory of some embodiments of the present invention has particular application to mountain bikes. However, some embodiments may be suited for use with other kinds of bicycles.

It will be appreciated that the bicycle has a frame, as that term is commonly understood in the art. The frame will be understood to include a seat tube, as that term is understood in the art. The seat tube has an entrance or opening.

The bicycle will also be understood to include a seat assembly having a seat and a seat post. The seat is connected to a first end of the seat post, this being the “upper” end of the seat post. In other words, the end that is farthest from the frame (and the ground) in use. The seat is connected to the first end of the post via an appropriate connection mechanism readily apparent to a person skilled in the art. It will be further understood that at least a portion of the seat post is configured to be inserted into the entrance of the seat tube such that, in use, the seat post may slide telescopically within the seat tube to adjust the height of the seat (relative to the frame).

More complex seat posts may include a piston, with the seat mounted to the upper end of the piston, and which is slideably moveable within a tube housing to adjust the height of the seat (relative to the frame). Such seat posts may incorporate electronic and pneumatic operating systems operable by the user using a switch or button mounted to the handle bars or another part of the bicycle frame within easy reach of the rider while in motion. Some embodiments of the invention have particular application to, but are not limited to, those bicycles having a seat configured to be adjusted while the bicycle is being ridden. These bicycles are well known in the art. In such cases, there is typically no opportunity to wipe or clean the seat post in between adjustments of the seat. Accordingly, it is especially important that debris be effectively prevented from settling on the seat post and/or entrance of the seat tube in the first place.

Reference shall now be made through the remainder of the present specification to embodiments of the present invention being used with a seat post. However, it should be understood that this term covers both conventional seat posts, which are inserted into the seat tube, and the more complex seat posts incorporating a piston within a tube housing as discussed above.

It will be appreciated that the accessory may be provided to the consumer as a kit, which includes the elongate guard, the guide, and at least one or more fasteners to mount the components of the accessory to the frame of the bicycle with which it is to be used. Alternatively, the guard and guide may be provided separately, allowing the consumer to mix and match the components depending on the size of the bicycle.

The accessory of some embodiments of the present invention will be understood to include a guard having a first end and a second end. It will be understood that in use, the guard is orientated substantially parallel to the seat post, with the first end of the guard being its uppermost end. In use, the guard may be proximate the seat post, but leaves clearance between the two. This may contribute to allowing the seat post to retain its full range of motion.

The guard may include a substantially flat panel having a width dimension and an elongate dimension. This may contribute to providing effective protection to the seat post, as well as to the ease of manufacture of the guard. However, this is not intended to be limiting, and other configurations may be employed without deviating from the scope of the invention.

It will be understood that the guard is elongate. In other words, the guard is relatively long and thin. The elongate dimension of the guard may be such that, in use, the guard extends downward beyond the entrance of the seat tube when the seat is at its highest position (and the seat post is accordingly in its position of maximal extension). One of ordinary skill in the art will readily arrive at an elongate dimension (or range thereof) that achieves this for a given bicycle.

Dimensioning the guard in this manner may allow the guard to provide protection to the entrance of the seat tube, thus helping to prevent debris from settling on or around same. This may help prevent debris from subsequently entering the seat tube when the seat post is being adjusted within same. The width dimension of the guard may be at least equal or greater than the diameter of the seat post and the seat tube. This may be conducive to the guard protecting the seat post and/or the entrance of the seat tube from debris. One of ordinary skill in the art will readily arrive at an appropriate dimension (or range thereof) for the width of the seat post.

It will also be appreciated that the width dimension of the guard may vary along its longitudinal dimension. For example, the guard may have a tapered configuration and/or it may have a wider portion and a narrower portion. Any suitable variations may be employed without deviating from the scope of the invention.

In some embodiments, a portion of the guard proximate its first end has an increased width. Specifically, the width is at least equal to the width of the connection mechanism between the seat and the seat post. The guard may thus provide especially effective protection to the connection mechanism.

It will be understood that the first end of the guard is configured to, in use, be connected to the seat assembly proximate the first end of the seat post. It will further be understood that the second end of the guard is not fixed to any other component.

The guard may be connected to the underside of the seat. This may be convenient as the guard may be readily attached to the existing structure of the seat, such as to its “saddle rails,” as that term is understood in the art. It may also mean that the guard protects the connection mechanism in use.

Moreover, the seat typically protrudes some distance backward (relative to the frame) from the seat post in most bicycles. Accordingly, the guard may easily be connected such that, in use, it is substantially parallel to the seat post while also leaving clearance therefrom. However, this is not intended to be limiting. The guard may alternatively be connected to the connection mechanism, for instance.

In some embodiments, the guard may even be connected to the first end of the seat post itself. In this case, the first end of the guard may include a lip or ledge substantially perpendicular to the remainder of the guard. This acts as a mechanism via which the guard is connected to the first end of the seat post. This ensures that there is clearance between the guard and the seat post in use so as not to inhibit the travel of the seat post.

It will be understood that the elongate dimension of the guard may depend on the position at which it is connected to the seat assembly. As previously noted, when in use, the guard is dimensioned such that it effectively covers a substantial portion of the seat post as well as at least the top of the seat tube.

The first end of the guard may include one or more connection points. In some embodiments, these are in the form of apertures or holes via which fasteners (such as cable ties or strapping in the form of hook and loop material such as VELCRO™) are passed to effect quick and easy connection of the guard to the seat assembly. These types of fasteners are readily available and do not require tools to secure them in place. However, reference to these types of fasteners is not intended to be limiting, and one of ordinary skill in the art will readily appreciate and envision other suitable mechanisms for connecting the guard to the seat assembly, and corresponding configurations of the connection points on the guard.

The guide (discussed below) of the accessory of some embodiments allows the guard to be connected relatively loosely to the seat assembly. This represents a significant advantage of the accessory of such embodiments over the art.

Due to the guide constraining the horizontal movement (and position) of the guard, the latter may not need to be rigidly connected to the seat assembly, such as to retain the guard in a parallel orientation relative to the seat post. There may not be a need for the use of screws or other relatively robust fasteners requiring precision of installation in some embodiments. Rather, the guard may be connected in a relatively straightforward manner, using common fasteners easily and affordably obtainable by a user.

The accessory of some embodiments will be understood to include a guide configured to, in use, cooperate with the guard. It will be understood that, in use, a portion of the guard passes slideably through the guide.

In use, the guide substantially constrains the horizontal movement and/or displacement of the guard. By this is meant both displacement in a forward and backward direction (relative to the frame), thus ensuring the guard remains substantially parallel to the seat post and substantially in alignment with the seat post. At the same time, the guide allows the guard to move freely up and down in a manner complementary to the movement of the seat post when the height of the seat is adjusted. Accordingly, the guide may be formed in the style of a sleeve, hoop, or ring dimensioned to allow the free movement of the guard in a vertical direction while substantially constraining its horizontal movement, as described above.

In some embodiments, at least a portion of the guide has a substantially rectangular profile that defines an aperture into which the guard may be inserted and slideably move. This may be relatively most effective in constraining the horizontal movement of such embodiments of the guard. However, this is not intended to be limiting, and a variety of suitable profiles for the guard will be readily identified by one of ordinary skill in the art.

In embodiments where the width of the guard varies along its longitudinal dimension, the guide may be dimensioned such that the widest point of the guard may pass through it. This may be conducive to the ease of manufacture and mounting of the accessory. Alternatively, the guide may be dimensioned such that only a portion of the guard that is less than a certain width may pass through it. For example, in the above-discussed embodiments where the upper portion of the guard has an increased width, the guide may be configured such that only a remaining portion of the guard, such as that having a width approximately equal to the seat post itself, may pass therethrough. This may enable a closer fit of the guide about this portion of the guard, thus allowing the guide to more effectively constrain the horizontal movement of the guard.

However, one of ordinary skill in the art will appreciate that this may necessitate that the upper portion of the guard be dimensioned such that the range of motion of the seat post is not impeded. Specifically, it may be necessary to ensure that the upper portion of the guard is not excessively long such that it abuts the guide when the seat post is slid downwards, thus preventing the seat from being fully lowered. Alternatively, or additionally, it may necessitate that the guide be positioned below a certain height (relative to the frame) in use.

In providing a guide that substantially constrains the horizontal movement of the guard while permitting its free movement in a vertical direction, the accessory of some embodiments may offer significant advantages over the devices of the prior art. The guard, being unfixed at its second end, is able to complement the vertical movement of the seat post, thus allowing the seat post to retain its full range of motion. At the same time, by virtue of the guide, the guard remains substantially parallel to and in alignment with the seat post at all extensions of the latter, thus providing protection from debris when in use.

Furthermore, as indicated above, the presence of the guide means that the guard may be connected to the seat assembly in a relatively straightforward and versatile manner, using a range of readily-available fasteners. The correct position of the guard in use is assisted by the guide, rather than being dependent on the connection of the guard to the seat assembly. A further benefit is that the guard may be formed from relatively thin and lightweight material. It is not reliant on its intrinsic properties minimize movement and/or deflection in some embodiments. At a broader level, this allows the accessory to be relatively simple in construction, straightforward to mount, and generally user-friendly.

It will be understood that at least a portion of the guide may be configured to be engaged, mounted, or otherwise connected to the frame of the bicycle with which it is to be used. The guide may be mounted to the seat tube of the frame such that, in use, it is proximate the second end of the guard when the seat post is in its position of maximal extension. This may be most effective in constraining the horizontal movement of the guard.

The guide may include an aperture such that it is a closed loop, substantially complementary to the dimensions of the seat tube. In such embodiments, the guide is installed simply by removing the seat post and slipping the guide over the top of the seat tube. The guide may be held in place via a friction fit about the seat post. This friction fit may be supplemented using fasteners or the like.

In other embodiments, to secure the guide to the seat tube, the guide may include or provide for a clamp. This may mean that there is no need to remove the seat post in order to mount the guide to the seat tube. The clamp may be configured as a partially open loop, such that it may be slipped around the exterior of the seat post via the opening. However, this is not intended to be limiting.

The clamp may be configured to effect connection of the guide to the frame on its own (such as by being configured to “grip” the frame in a friction fit when mounted thereto). Alternatively, or in addition, the clamp may include one or more connection points through which common fasteners such as cable ties may be passed, which in turn connect the clamp (and hence the guide) to the frame. In other embodiments, the clamp may be mounted to the frame via over center latches or the like, which when biased closed, bring the ends of the open loop closer together, thus clamping onto the seat post. Persons of ordinary skill in the art will readily appreciate other ways in which the clamp may be secured to the seat tube without deviating from the scope of the invention.

In use, the clamp may be at the same vertical level (relative to the frame) as the guide. This may be conducive to the ease of manufacture of the accessory. It may even allow the clamp and guide to be of unitary construction. It may also be conducive to the ease of use of the accessory. Accordingly, in some embodiments of the invention, the clamp is configured to connect to the exterior of the seat tube, proximate (though downwards of) the entrance of the seat tube.

However, this is not intended to be limiting. For instance, it is within the scope of the present invention for the clamp to, in use, be positioned lower than the guide, and to be connected to a portion of the frame other than the seat tube, where the clamp and guide are connected to one another via an intermediate structure(s). It will be understood that the clamp is configured and dimensioned appropriately to the portion of the frame to which it is intended to be connected.

Furthermore, in some embodiments, the clamp is configured to be adaptable to a frame (or the relevant portion thereof) having a range of dimensions. This may be achieved by, for example, the clamp being manufactured from a relatively flexible (that is to say, elastically deformable) material and/or by the clamp being appropriately dimensioned (such as by having relatively thin walls which permit of a degree of elastic deformation). It may also be due to the clamp having an adjustment mechanism, as will be readily appreciated by one of ordinary skill in the art, and/or by means of the clamp being configured to accommodate fasteners (as discussed above), which may themselves be adjustable.

In some embodiments, the components of the accessory (that is to say, the guard, the guide and the clamp) are manufactured from carbon fiber. This may be preferred due to its lightweight properties and strength. Furthermore, carbon fiber also has a degree of material memory such that it can elastically deform (such as by flexing or bending) as may be required in order to connect the clamp (or guide) to the bicycle but then return to its original shape.

However, this is not intended to be limiting and some or all of the components may equally be manufactured from a suitable plastic, or any other suitable material. For example, the guide may be formed from plastics material such as acrylonitrile butadiene styrene (ABS) or polyvinyl chloride (PVC) to better withstand the forces being applied to it. Likewise, the guide may be formed from a similar material. In some embodiments, the guide may include reinforcement bands of metal for structural integrity. One of ordinary skill in the art will recognize that other materials that are functionally appropriate for the accessory of some embodiments of the present invention.

Turning now to consider the mounting of the accessory to a bicycle according to an embodiment of the present invention, this may be achieved by connecting the first end of the guard to the underside of the seat. The second end of the guard may be passed through the guide. If not already installed prior to the steps described above, the guide may then be connected to the frame and secured, if appropriate, via the clamp. Mounting the components of the accessory in the above sequence is not intended to be limiting and one of ordinary skill in the art will appreciate other sequences via which this may be achieved.

Some embodiments of the present invention have a number of advantages over conventional devices for protection of adjustable seat posts from debris, including, but not limited to: (1) providing an accessory that allows the seat post (and hence the seat) to retain its full range of motion; (2) at the same time, providing an accessory that provides effective protection from debris to the seat post, seat tube, and/or seat assembly at every extension of the seat tube; (3) providing an accessory comprised of relatively simple components that are straightforward to manufacture and are relatively robust in use; (4) providing an accessory that may be made of a range of suitable materials and in particular, allowing the guard to be manufactured from a relatively lightweight and thin material; (5) providing an accessory that is user-friendly, being straightforward to mount and use; and/or (6) enabling the guard to be connected to the seat assembly in a straightforward and versatile manner using common fasteners that are readily available to the user (such as cable ties) and without the need for more robust and complex fasteners for rigidly constraining the position of the guard.

In all figures herein, like features are assigned a like numeral.

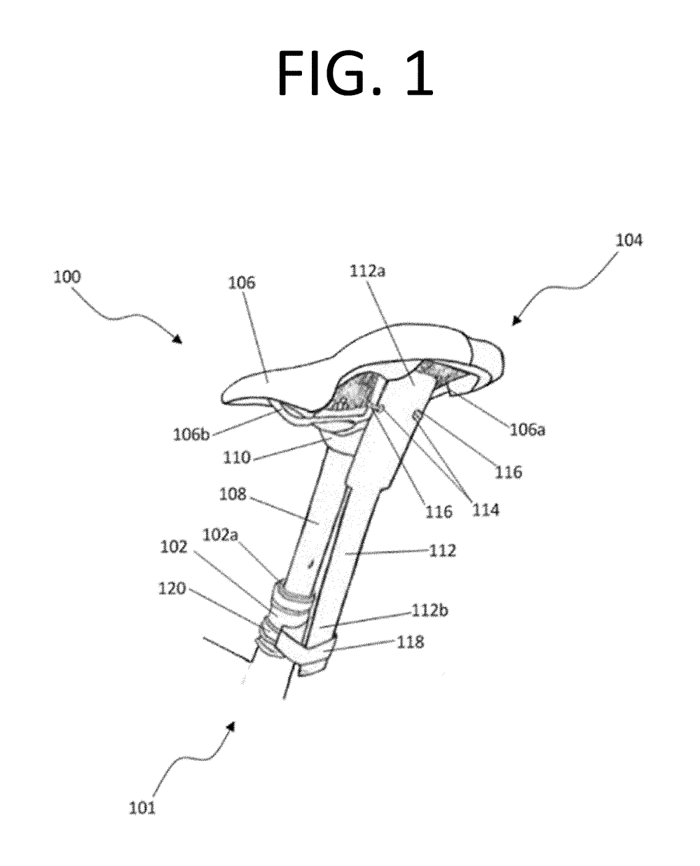

FIG. 1 is a schematic showing the accessory (generally indicated by arrow 100) according to an embodiment of the present invention mounted to a bicycle (not visible). The bicycle includes a frame (101). The frame includes a seat tube (102) having an entrance (102a). The bicycle also includes a seat assembly (104) that includes the seat (106) and a seat post (108). The underside (106a) of the seat is connected to the seat post via a connection mechanism (110) that engages with the saddle rails (106b).

The seat post (108) is configured to slide within the seat tube (102), thus facilitating adjustment of the seat (106) relative to the frame (101). The principle of operation is the same for the more complex, switch or button operated, seat height adjustment mechanisms in which the seat is effectively mounted to an end of a piston, the piston moving in and out a housing which is inserted into the seat tube. This adjustment of the seat may be desirable when the bicycle is to be ridden by a different user or for greater clearance when standing on the pedals (not shown), such as when downhilling.

The accessory (100) includes an elongate guard (112) which, in this embodiment, is formed as a substantially flat panel. The guard (112) includes a first, upper, end (112) configured to be connected to the seat assembly (104)—in this embodiment, to the saddle rails (106b) at the underside (106a) of the seat (106) such that, when mounted, there is a degree of clearance between the guard and the seat post (108). Accordingly, the first end (112a) of the guard (112) includes connection points (114) in the form of holes through which fasteners (116), such as cable ties in the illustrated embodiment, may be passed to effect connection of the guard to the saddle rails (106b).

It can be seen that in this embodiment, a portion of the guard (112) proximate its first end (112a) has an increased width relative to that at its second end (112b). The width of this portion is substantially equal to that of the connection mechanism (110). This is so that the guard provides adequate protection from debris coming into contact with the connection mechanism. It can further be seen that the width of the remainder of the guard (112) is substantially equal to that of the seat post (108).

The accessory (100) also includes a guide (118), in the style of a short sleeve, configured and dimensioned to allow the second end (112b) of the guard (112) to pass relatively loosely through it in a vertical direction. The interior of the guide, apart from the portion that abuts the seat post (108), is substantially rectangular in profile, to best match the dimension of the second end of the guard. This allows the guard (112) to move with the seat post (108) when, in use, the latter is slid up or down in order to adjust the height of the seat (104) relative to the frame (101) of the bike. This helps to enable the seat post (103) to retain its full range of motion.

At the same time, the guide (118) is configured and dimensioned to substantially constrain the horizontal movement of the guard (112). This relates both to the forward and backward movement of the guard (relative to the frame (101)), thus ensuring it remains substantially parallel to the seat post (108) in use. The guide also limits the side-to-side movement of the guard (relative to the frame), thus ensuring it remains substantially in alignment with the seat post in use. This provides the best protection for the seat post from debris thrown up by the rear tire.

In this embodiment, the guide (118) is configured to be connected to the exterior of the seat tube (102) proximate to, though downward from, its entrance (102a). To this end, one face of the guide is configured to be substantially complementary to the profile or curvature of the exterior of the seat tube. Furthermore, the guide (118) includes an integral clamp (120) configured to engage with the exterior of the seat tube (102), thus connecting the guide to the frame (101). The clamp includes connection points (not shown) through which common fasteners, such as cable ties (not shown), may be passed to help effect connection of the clamp to the exterior of the seat tube.

Being formed from a resilient material that is capable of some elastic deformation, such as carbon fiber, the clamp (120) elastically deforms such that it can be slipped about or over the seat tube (102) when being mounted and then secured by the fasteners (not shown) to enhance its grip on the seat tube (if necessary).

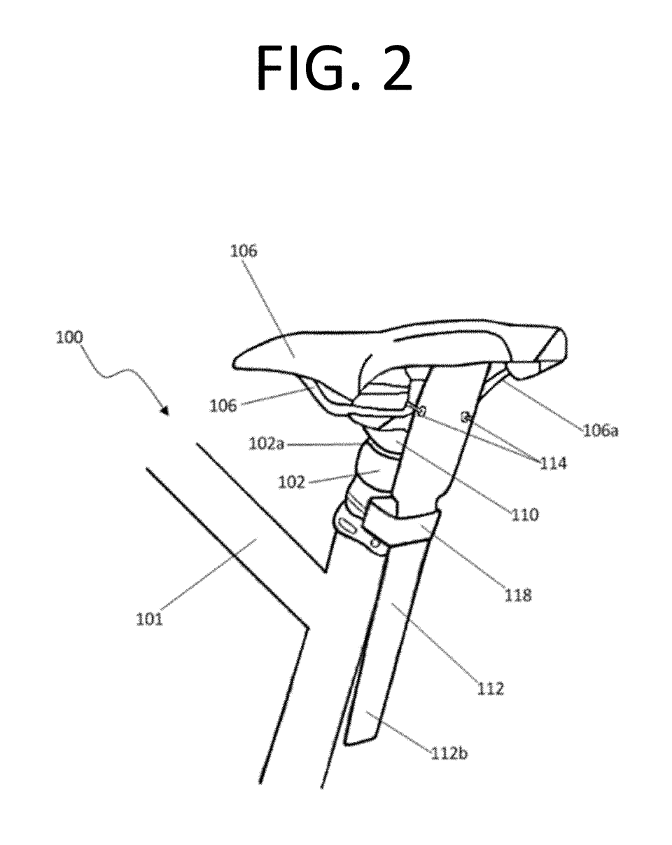

FIG. 2 is a schematic showing the accessory (100) according to the same embodiment of the present invention, where the seat (106) is in a lowered position relative to the frame (101), in contrast to the raised position of FIG. 1. It will be appreciated that the seat post (substantially not visible in this view) has been slid fully into the seat tube (102), as evidenced by the connection mechanism (110) abutting the entrance (102a) of the seat tube. It will be appreciated that this is rendered possible by virtue of the configuration of the accessory (100). In particular, the free second end (112b) of the guard (112) allows it to cooperate with the motion of the seat post (not visible), such that the seat retains its full range of motion.

This, in turn, is rendered possible by the presence of the guide (118), which ensures that the guard (112) remains substantially parallel to, and in alignment with, the seat post (not visible) as the latter moves up and down. This ensures that the guard provides effective protection to the seat post (not shown) throughout its full range of motion. This prevents or limits any debris that may contact the seat post and which may otherwise be drawn into its interior via the entrance (102a). It will be appreciated that the accessory (100) functions in a similar manner to provide protection to the seat post (108) as the seat (106) is moved between the raised and lowered positions shown, respectively, in FIGS. 1 and 2.

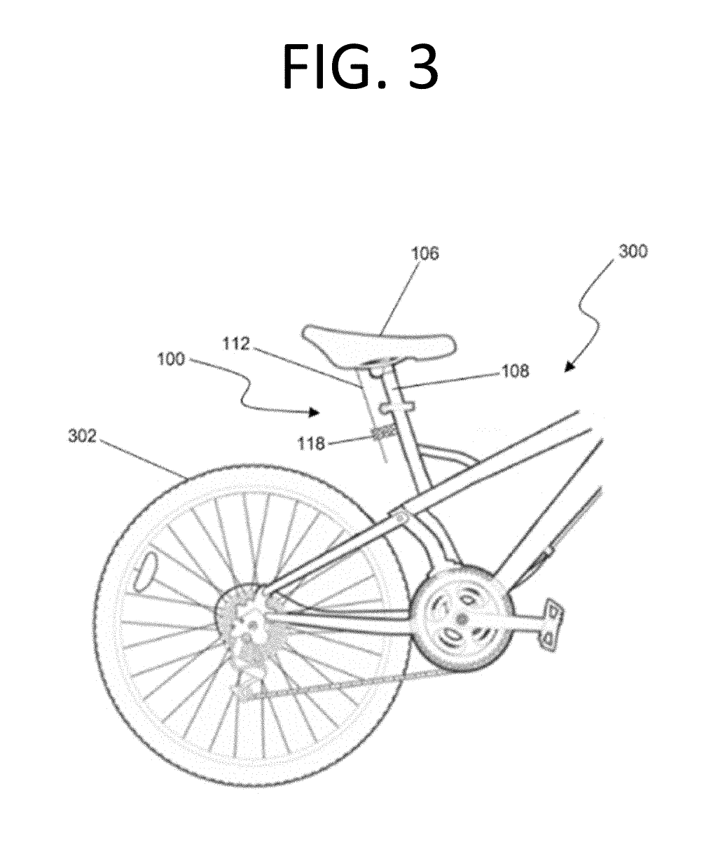

FIG. 3 is a profile view showing the accessory (100) according to the same embodiment of the present invention mounted to a bicycle (300), with the seat (106) in a raised position. The configuration of the accessory is substantially as described above with reference to FIGS. 1 and 2.

In this view, the position of the accessory (100) relative to the rear tire (302) of the bicycle (300) can be better appreciated. It will be seen that the guard (112) of the accessory (100) is mounted proximate the seat post (108), thus providing maximal protection to same from any debris thrown up by the rear tire (302). The guide (118) confines the movement of the guard while the bicycle is being ridden so that the seat post is substantially shielded at all times. The guide also limits the movement of the guard to a vertical motion as the seat (106) is raised and lowered according to the requirements of the rider. It will be understood that it is not beyond the scope of the invention for the accessory (100) to be used in combination with a mudguard (not shown) of a conventional kind mounted proximate the rear tire (302) and designed to arrest the flight of debris early in its trajectory.

All references, including any patents or patent applications that may be cited in this specification are hereby incorporated by reference. No admission is made that any such reference constitutes prior art. The discussion of the references states what their authors assert, and the applicants reserve the right to challenge the accuracy and pertinency of the cited documents. It will be clearly understood that although a number of prior art publications may be referred to herein, this reference does not constitute an admission that any of these documents form part of the common general knowledge in the art in New Zealand or in any other country.

Unless the context clearly requires otherwise, throughout the description and the claims, the words “comprise”, “comprising”, and the like, are to be construed in an inclusive sense as opposed to an exclusive or exhaustive sense, that is to say, in the sense of “including, but not limited to”.

It will be readily understood that the components of various embodiments of the present invention, as generally described and illustrated in the figures herein, may be arranged and designed in a wide variety of different configurations. Thus, the detailed description of the embodiments of the present invention, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, reference throughout this specification to “preferred embodiments” or “exemplary embodiments”, or similar language means that a particular feature, structure, or characteristic described in connection with the embodiment is included in at least one embodiment of the present invention. Thus, appearances of the phrases “in preferred embodiments” or “in exemplary embodiments”, or similar language throughout this specification do not necessarily all refer to the same group of embodiments and the described features, structures, or characteristics may be combined in any suitable manner on one or more embodiments.

It should be noted that reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1. An accessory for a bicycle, the bicycle comprising a frame and a seat assembly, the seat assembly comprising a seat and a seat post, the seat connected to a first end of the seat post, the accessory comprising:
an elongate guard having a first end and a second end; and
a guide configured to, in use, be connected to the frame and to cooperate with the guard, wherein
the guard is configured to, in use, be substantially parallel to the seat post, and
the first end of the guard is configured to, in use, be connected to the seat assembly proximate the first end of the seat post.

2. The accessory as claimed in claim 1, wherein the guard comprises a substantially flat panel having a width dimension and an elongate dimension.

3. The accessory as claimed in claim 2, wherein the width dimension of the guard is at least equal or greater than the diameter of the seat post.

4. The accessory as claimed in claim 2, wherein the first end of the guard is wider than the second end of the guard.

5. The accessory as claimed in claim 1, wherein the first end of the guard comprises one or more connection points.

6. The accessory as claimed in claim 5, wherein the connection points comprise apertures or holes through which fasteners are passed.

7. The accessory as claimed in claim 6, wherein
the accessory comprises fasteners, and
the fasteners comprise cable ties or hook and loop material.

8. The accessory as claimed in claim 1, wherein the guide is configured as a sleeve, a hoop, or a ring.

9. The accessory as claimed in claim 8, wherein at least a portion of the guide has a substantially rectangular profile.

10. The accessory as claimed in claim 8, wherein the guide slideably receives at least a portion of the guard.

11. The accessory as claimed in claim 1, wherein at least a portion of the guide is configured to be mounted or engaged to a seat tube of the frame of the bicycle.

12. The accessory as claimed in claim 11, wherein the guide comprises a clamp to secure the accessory to the seat tube.

13. The accessory as claimed in claim 1, wherein the guard and the guide are formed of plastics material.

14. The accessory as claimed in claim 1, wherein the guard and the guide are formed of carbon fiber.

15. A kit for an accessory for a bicycle, comprising:
the accessory; and
at least one fastener, wherein
the accessory comprises an elongate guard having a first end and a second end and a guide configured to, in use, be connected to a frame of the bicycle and to cooperate with the guard,
the guard is configured to, in use, be substantially parallel to a seat post of the bicycle, and
the first end of the guard is configured to, in use, be connected to a seat assembly of the bicycle proximate a first end of the seat post.

16. The kit as claimed in claim 15, wherein the fasteners comprise cable ties or hook and loop material.

17. A method of mounting an accessory comprising an elongate guard and a guide to a bicycle, comprising:
connecting the guide to a frame of the bicycle; and
connecting a first end of the guard to a seat assembly proximate a first end of a seat post and passing a second end of the guard through the guide, wherein
the guard is configured to, in use, be substantially parallel to the seat post.

18. The method as claimed in claim 17, wherein the frame comprises a seat tube, and the guide is connected to the seat tube.

19. The method as claimed in claim 17, wherein the first end of the guard is connected to the seat assembly with one or more fasteners.

20. The method as claimed in claim 20, wherein the fasteners comprise cable ties or hook and loop material.
